(19) United States
(12) Patent Application Publication
(10) Pub. No.: US 2010/0232384 A1
(43) Pub. Date: Sep. 16, 2010

(54) CHANNEL ESTIMATION BASED UPON USER SPECIFIC AND COMMON REFERENCE SIGNALS

(75) Inventors: Amir Farajidana, San Diego, CA (US); Kapil Bhattad, San Diego, CA (US); Alexei Y. Gorokhov, San Diego, CA (US); Juan Montojo, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/722,502

(22) Filed: Mar. 11, 2010

Related U.S. Application Data
(60) Provisional application No. 61/160,215, filed on Mar. 13, 2009.
(60) Provisional application No. 61/167,107, filed on Apr. 6, 2009.
(60) Provisional application No. 61/221,004, filed on Jun. 26, 2009.
(60) Provisional application No. 61/221,489, filed on Jun. 29, 2009.

(51) Int. Cl. H04W 4/00

(52) U.S. Cl. 370/329

(57) ABSTRACT

Systems and methods are disclosed to facilitate wireless communications. The systems and methods include generating one or more user specific reference signals (UE-RS) and one or more common reference signals (CRS) at a transmitting node; transmitting the UE-RS and the CRS to a user (UE) using a transmission scheme in accordance with a mapping function to enable the UE to estimate a channel based upon CRS observations, UE-RS observations, and the mapping function; and transmitting data using the transmission scheme in accordance with the mapping function.

### CROSS-REFERENCE TO RELATED APPLICATIONS

This application claims the benefit pursuant to 35 U.S.C. 119(e) of U.S. Provisional Application No. 61/160,215, filed Mar. 13, 2009; U.S. Provisional Application No. 61/167,107, filed Apr. 6, 2009; U.S. Provisional Application No. 61/221,004, filed Jun. 26, 2009; and U.S. Provisional Application No. 61/221,489, filed Jun. 29, 2009; which applications are specifically incorporated herein, in their entirety, by reference.

### BACKGROUND

I. Field

The following description relates generally to wireless communications systems, and more particularly to channel estimation based upon user specific and common reference signals for long term evolution (LTE)-Advanced systems.

II. Relevant Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including E-UTRA, and orthogonal frequency division multiple access (OFDMA) systems.

An orthogonal frequency division multiplex (OFDM) communication system effectively partitions the overall system bandwidth into multiple (N_{F}) subcarriers, which may also be referred to as frequency sub-channels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier. Thus, OFDM may be used to combat inter-symbol interference (ISI) caused by frequency selective fading, which is characterized by different amounts of attenuation across the system bandwidth.

Generally, a wireless multiple-access communication system can concurrently support communication for multiple wireless terminals that communicate with one or more base stations via transmissions on forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into N_S independent spatial channels, which are also referred to as spatial channels, where N_{S}≦min{N_{T}, N_{R}}. Generally, each of the N_S independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows estimation of the forward link channel from the reverse link channel. This enables an access point to extract transmit beam-forming gain on the forward link when multiple antennas are available at the access point.

Higher order MIMO operation with transmission over 8 spatial channels is envisioned in LTE-Advanced systems to improve system performance. Techniques for improved user experience and system performance for LTE-Advanced systems are therefore highly sought after, such as improved channel estimation and demodulation techniques.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Systems and methods are disclosed to facilitate wireless communications. The systems and methods include generating one or more user specific reference signals (UE-RS) and one or more common reference signals (CRS) at a transmitting node; transmitting the UE-RS and the CRS to a user (UE) using a transmission scheme in accordance with a mapping function to enable the UE to estimate a channel based upon CRS observations, UE-RS observations, and the mapping function; and transmitting data using the transmission scheme in accordance with the mapping function.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high level block diagram of a system that employs demodulation reference components for wireless communications.

FIG. 2 illustrates an example communications apparatus.

FIG. 3 illustrates a multiple access wireless communication system.

FIGS. 4 and 5 illustrate example communications systems.

FIG. 6A illustrates a communication system that allows a user to perform demodulation and channel estimation based upon transmitted user specific reference signals (UE-RS) and common reference signals (CRS).

FIG. 6B is a flowchart that illustrates a process to implement channel estimation.

FIG. 7 illustrates the mapping function components of an exemplary mapping function.

FIG. 8 illustrates a particular extension of UE-RS patterns to a higher number of channels based upon different patterns.

FIG. 9 illustrates another particular extension of UE-RS patterns to a higher number of channels based upon different patterns.

FIG. 10 illustrates a reconfiguration of a pattern from FIG. 9 to implement time staggering.

FIG. 11 illustrates different groups of channels that are time staggered.

FIG. 12 is a flowchart that illustrates a process to create UE-RS blocks.

### DETAILED DESCRIPTION

Systems and methods are disclosed to facilitate wireless communications. The systems and methods include generating one or more user specific reference signals (UE-RS) and one or more common reference signals (CRS) at a transmitting node; transmitting the UE-RS and the CRS to a user (UE) using a transmission scheme in accordance with a mapping function to enable the UE to estimate a channel based upon CRS observations, UE-RS observations, and the mapping function; and transmitting data using the transmission scheme in accordance with the mapping function.

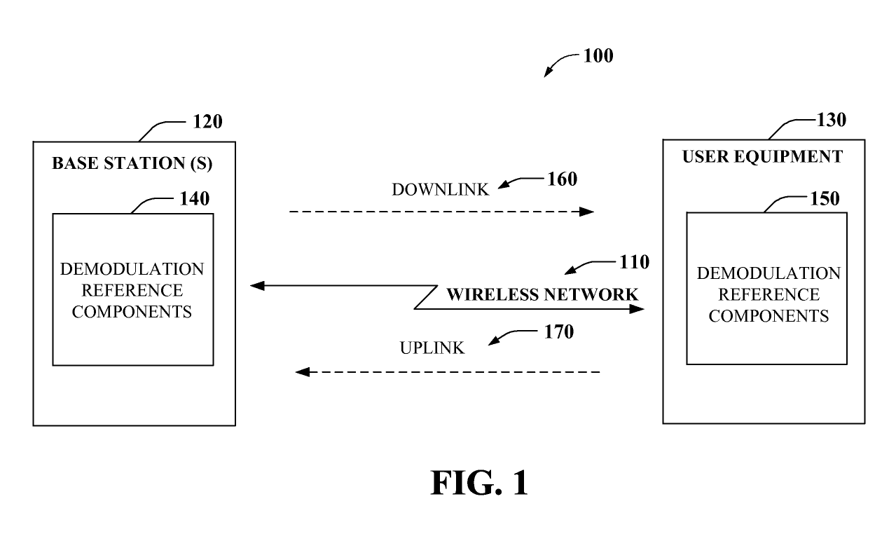

Referring now to FIG. 1, a system 100 employs demodulation reference components in a wireless network 110. The system 100 includes one or more base stations 120 (also referred to as a node, evolved node B-eNB, serving eNB, target eNB, femto station, pico station) which can be an entity capable of communication over the wireless network 110 to various devices 130. For instance, each device 130 can be an access terminal (also referred to as terminal, user equipment, mobility management entity (MME) or mobile device). The base station 120 and device 130 can include a demodulation reference component 140 and 150 to facilitate wireless communications and/or channel estimation. As shown, the base station 120 communicates to the station 130 via downlink 160 and receives data via uplink 170. Such designation as uplink and downlink is arbitrary as the device 130 can also transmit data via downlink and receive data via uplink channels. It is noted that although two components 120 and 130 are shown, that more than two components can be employed on the network 110, where such additional components can also be adapted for signal processing described herein.

As will be described, in one embodiment, user specific reference signals (UE-RS) and common reference signals (CRS) may be processed by demodulation reference components 140 of base station/transmitting node 120 and are transmitted through downlink 160 to user equipment (UE) 130. UE 160 performs demodulation and channel estimation based upon the UE-RS and CRS utilizing demodulation reference components 150. The reference signals may be precoded or unprecoded. Further, the UE-RS may be transmitted in spatial directions specific to the UE.

It is noted that the system 100 can be employed with an access terminal or mobile device, and can be, for instance, a module such as an SD card, a network card, a wireless network card, a computer (including laptops, desktops, personal digital assistants PDAs), mobile phones, smart phones, or any other suitable terminal that can be utilized to access a network. The terminal accesses the network by way of an access component (not shown). In one example, a connection between the terminal and the access components may be wireless in nature, in which access components may be the base station and the mobile device is a wireless terminal. For instance, the terminal and base stations may communicate by way of any suitable wireless protocol, including but not limited to Time Divisional Multiple Access (TDMA), Code Division Multiple Access (CDMA), Frequency Division Multiple Access (FDMA), Orthogonal Frequency Division Multiplexing (OFDM), FLASH OFDM, Orthogonal Frequency Division Multiple Access (OFDMA), or any other suitable protocol.

Access components can be an access node associated with a wired network or a wireless network. To that end, access components can be, for instance, a router, a switch, or the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

The techniques described herein may be implemented by various means. For example, these techniques may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors.

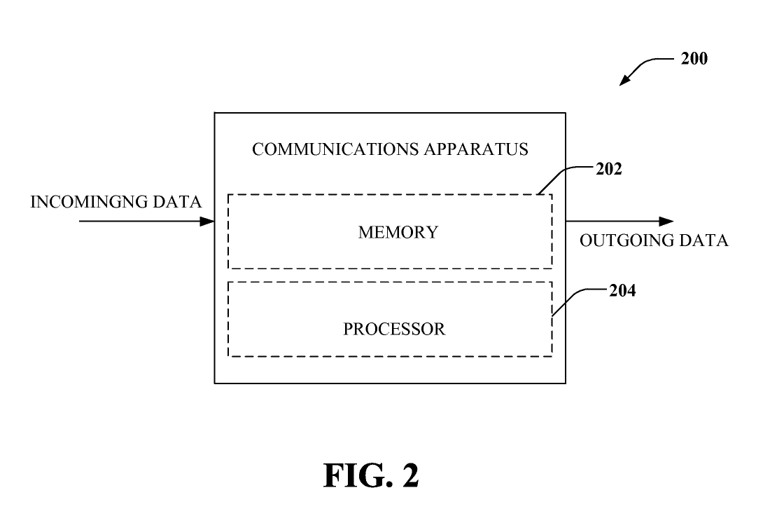

FIG. 2 illustrates a communications apparatus 200 that can be a wireless communications apparatus, for instance, such as a wireless terminal. Additionally or alternatively, communications apparatus 200 can be resident within a wired network. Communications apparatus 200 can include memory 202 that can retain instructions for performing a signal analysis in a wireless communications terminal. Additionally, communications apparatus 200 may include a processor 204 that can execute instructions within memory 202 and/or instructions received from another network device, wherein the instructions can relate to configuring or operating the communications apparatus 200 or a related communications apparatus.

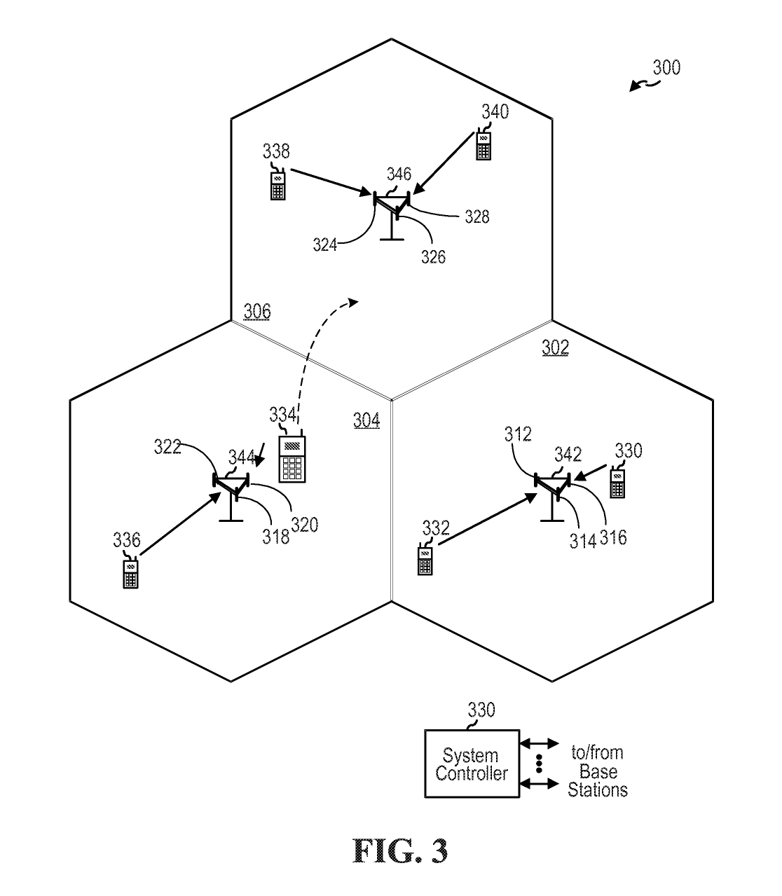

Referring to FIG. 3, a multiple access wireless communication system 300 is illustrated. The multiple access wireless communication system 300 includes multiple cells, including cells 302, 304, and 306. In the aspect the system 300, the cells 302, 304, and 306 may include a Node B that includes multiple sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 can include several wireless communication devices, e.g., User equipment or UEs, which can be in communication with one or more sectors of each cell 302, 304 or 306. For example, UEs 330 and 332 can be in communication with Node B 342, UEs 334 and 336 can be in communication with Node B 344, and UEs 338 and 340 can be in communication with Node B 346.

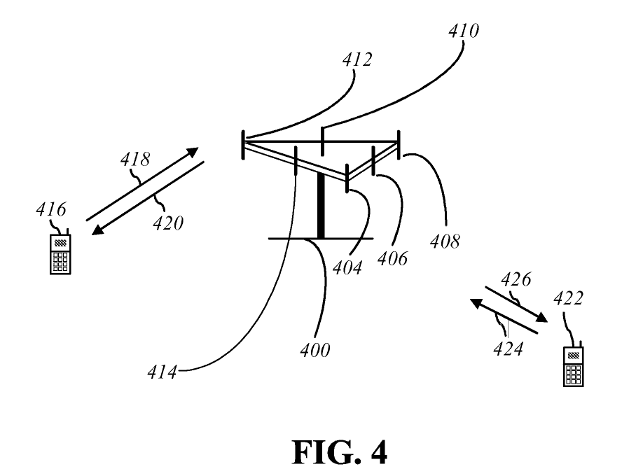

Referring now to FIG. 4, a multiple access wireless communication system according to one aspect is illustrated. An access point 400 (AP) includes multiple antenna groups, one including 404 and 406, another including 408 and 410, and an additional including 412 and 414. In FIG. 4, only two antennas are shown for each antenna group, however, more or fewer antennas may be utilized for each antenna group. Access terminal 416 (AT) is in communication with antennas 412 and 414, where antennas 412 and 414 transmit information to access terminal 416 over forward link 420 and receive information from access terminal 416 over reverse link 418. Access terminal 422 is in communication with antennas 406 and 408, where antennas 406 and 408 transmit information to access terminal 422 over forward link 426 and receive information from access terminal 422 over reverse link 424. In a FDD system, communication links 418, 420, 424 and 426 may use different frequency for communication. For example, forward link 420 may use a different frequency then that used by reverse link 418.

Each group of antennas and/or the area in which they are designed to communicate is often referred to as a sector of the access point. Antenna groups each are designed to communicate to access terminals in a sector, of the areas covered by access point 400. In communication over forward links 420 and 426, the transmitting antennas of access point 400 utilize beam-forming in order to improve the signal-to-noise ratio of forward links for the different access terminals 416 and 424. Also, an access point using beam-forming to transmit to access terminals scattered randomly through its coverage causes less interference to access terminals in neighboring cells than an access point transmitting through a single antenna to all its access terminals. An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

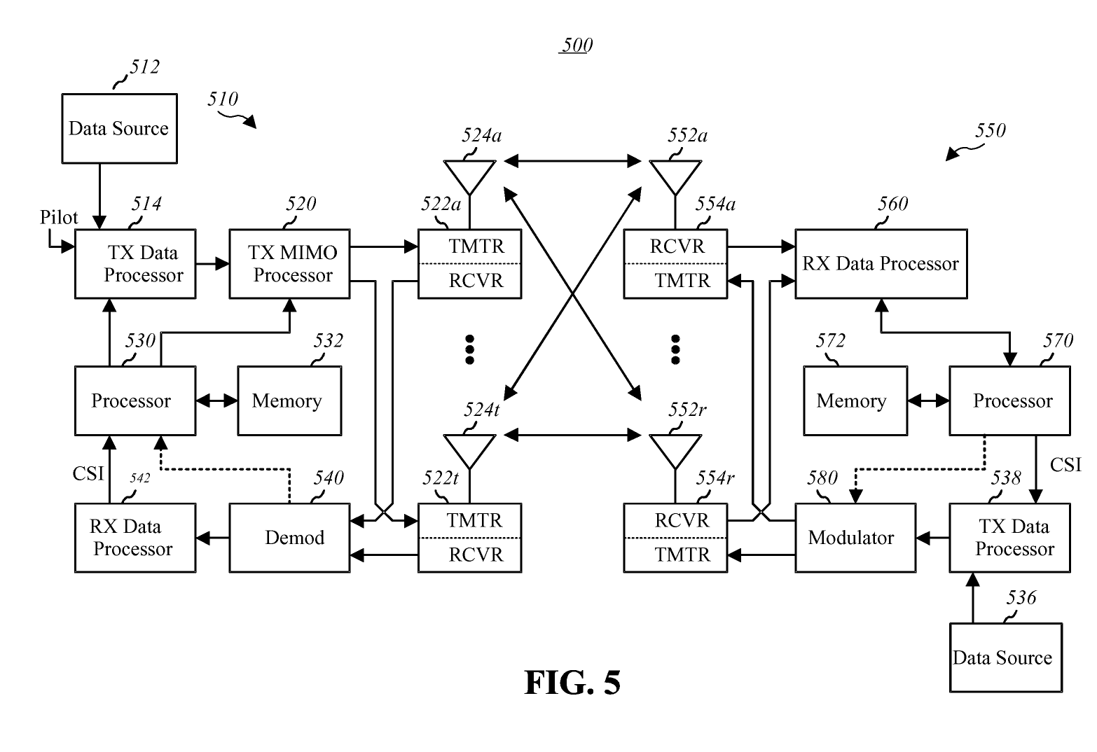

Referring to FIG. 5, a system 500 illustrates a transmitter system 510 (also known as the access point or transmitting node) and a receiver system 550 (also known as access terminal or user equipment (UE)) in a MIMO system 500. At the transmitter system 510, traffic data for a number of data streams is provided from a data source 512 to a transmit (TX) data processor 514. Each data stream is transmitted over a respective transmit antenna. TX data processor 514 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 530.

The modulation symbols for all data streams are then provided to a TX MIMO processor 520, which may further process the modulation symbols (e.g., for OFDM). TX MIMO processor 520 then provides NT modulation symbol streams to NT transmitters (TMTR) 522a through 522t. In certain embodiments, TX MIMO processor 520 applies beam-forming weights to the symbols of the data streams and to the antenna from which the symbol is being transmitted. Beam-forming weights may also be applied to pilot data in the case of user-specific reference signals. Further, TX MIMO processor 520 may also employ precoding operations in the form of applying beam-forming weights to the symbols of data streams or pilots and may transmit a sum of weighted symbols to the antennas from which the symbol is being transmitted from.

Each transmitter 522 receives and processes a respective symbol stream to provide one or more analog signals, and further conditions (e.g., amplifies, filters, and up-converts) the analog signals to provide a modulated signal suitable for transmission over the MIMO channel. NT modulated signals from transmitters 522a through 522t are then transmitted from NT antennas 524a through 524t, respectively.

At receiver system 550, the transmitted modulated signals are received by NR antennas 552a through 552r and the received signal from each antenna 552 is provided to a respective receiver (RCVR) 554a through 554r. Each receiver 554 conditions (e.g., filters, amplifies, and down-converts) a respective received signal, digitizes the conditioned signal to provide samples, and further processes the samples to provide a corresponding “received” symbol stream.

An RX data processor 560 then receives and processes the NR received symbol streams from NR receivers 554 based on a particular receiver processing technique to provide NT “detected” symbol streams. The RX data processor 560 then demodulates, de-interleaves, and decodes each detected symbol stream to recover the traffic data for the data stream. The processing by RX data processor 560 is complementary to that performed by TX MIMO processor 520 and TX data processor 514 at transmitter system 510.

A processor 570 periodically determines which pre-coding matrix to use. Processor 570 formulates a reverse link message comprising a matrix index portion and a rank value portion. The reverse link message may comprise various types of information regarding the communication link and/or the received data stream. The reverse link message is then processed by a TX data processor 538, which also receives traffic data for a number of data streams from a data source 536, modulated by a modulator 580, conditioned by transmitters 554a through 554r, and transmitted back to transmitter system 510.

At transmitter system 510, the modulated signals from receiver system 550 are received by antennas 524, conditioned by receivers 522, demodulated by a demodulator 540, and processed by a RX data processor 542 to extract the reserve link message transmitted by the receiver system 550. Processor 530 then determines which pre-coding matrix to use for determining the beam-forming weights then processes the extracted message.

It should be noted that higher order MIMO operation with transmission of up to 8 spatial channels can be provided in LTE-Advanced systems. Furthermore, cooperative MIMO and multi-cell processing/coordination are considered as enabling techniques for improving the user experience and system performance. In these scenarios, one or more transmitting nodes can perform beam-forming/pre-coding operation to transmit information to one or more users over one or possible multiple spatial layers.

In the legacy LTE system, cell specific common RS (CRS) are transmitted for the antenna ports that are used for transmission of data and/or control. The number of CRS antenna ports may be limited to 4 in LTE Release 8. The CRS antenna ports may be obtained by antenna virtualization techniques from the “physical antennas” at the transmitter(s). Note that the number of CRS antenna ports can be smaller than physical antennas at the transmitter.

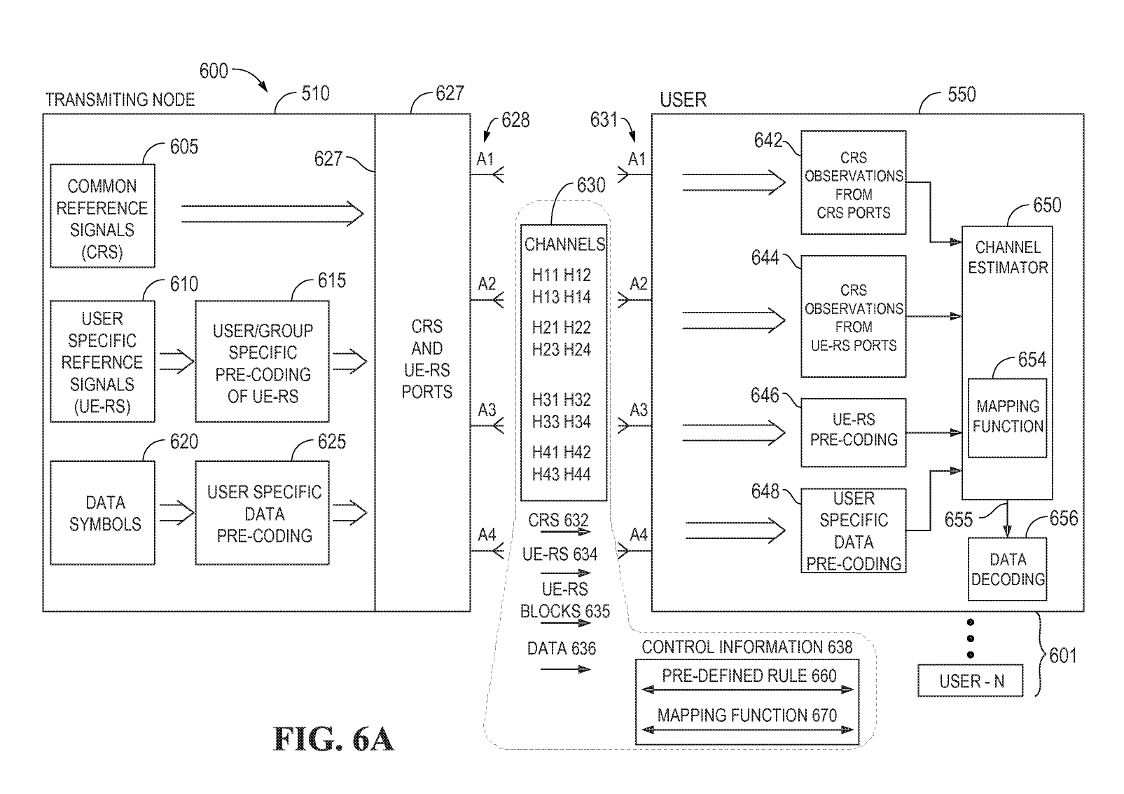

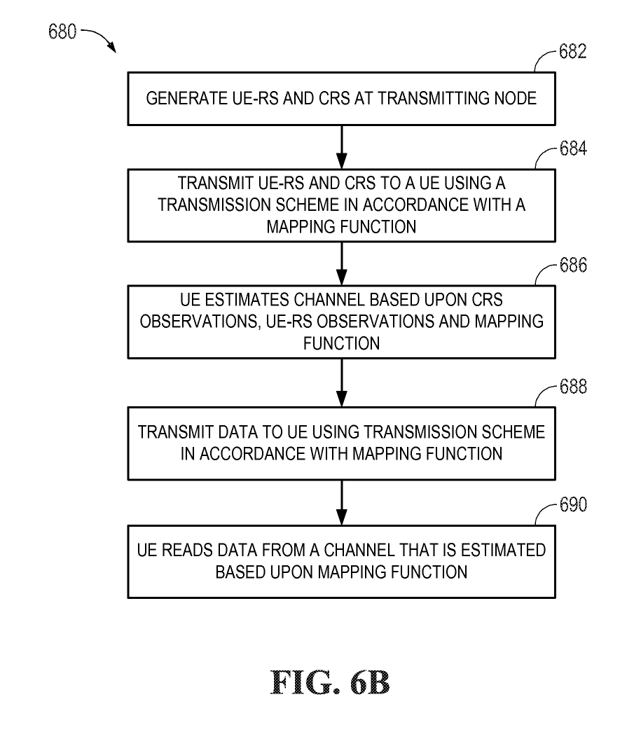

Referring to FIG. 6A, a communication system 600, similar to the communication system 500 of FIG. 5, illustrates the transmitter system 510 (e.g., an access point, base station, transmitting node, etc.) and the receiver system 550 (e.g., an access terminal, user equipment (UE), etc.) that allows for the UE 550 to perform demodulation and channel estimation based upon transmitted user specific reference signals (UE-RS) and common reference signals (CRS) from the transmitting node 510. It should be appreciated that the transmitting node 510 and the UE 550 are communications apparatus that include at least one memory and at least one processor (e.g., previously discussed with reference to FIG. 2) to implement functionality hereinafter described.

As previously described in FIG. 5, both the transmitter node 510 and the UE 550 include processors that execute instructions and memories and that retain instructions to enable demodulation and channel estimation. As will be described hereinafter, in some embodiments, the transmitting node 510 and the UE 550 further implement functions to allow for channel estimation based upon transmitted user specific reference signals (UE-RS) and common reference signals (CRS).

In one embodiment memory of the transmitting node 510 retains instructions for generating one or more user specific reference signals (UE-RS) 610 and one or more common reference signals (CRS) 605. Transmitting node 510 under the control of the processor transmits CRS 632 and UE-RS 634 to the user equipment (UE) 550 using a transmission scheme in accordance with a mapping function to enable the UE 550 to estimate a channel based upon CRS observations, UE-RS observations, and a mapping function. Data 636 is transmitted from the transmitting node 510 to the user 550 in accordance with the mapping function. UE 550 includes memory to retain instructions and a processor to execute instructions and implements a channel estimator 650 for channel estimation. Channel estimator 650 estimates channels based upon both received CRS 632 and received UE-RS 634. Further, the channel estimator 650 estimates channels based upon CRS observations 642 from CRS ports and UE-RS observations 644 from UE-RS ports.

CRS 632 and UE-RS 634 may be precoded or unprecoded. Further, spatial channels may be selected by the transmitting node 510 based upon the mapping function.

UE 550 can use a combination of CRS 605 and UE-RS 610 for channel estimation for the purpose of demodulation. Using CRS 605 can reduce additional overhead and may improve channel estimation performance.

In one embodiment, the transmitting node 510 generates common reference signals (CRS) 605, user specific reference signals (UE-RS) 610, user/group specific pre-coding of UE-RS 615, data symbols 620, and user specific data pre-coding 625 and transmits this data and signals through CRS and UE-RS ports 627 and antennas 628 (e.g. antennas 1-4 (A1, A2, A3, A4) as CRS 632, UE-RS 634, and data 636 to antennas 631 (e.g. antennas 1-4 (A1, A2, A3, A4) of UE 550. Also, as will be described in more detail later, transmitting node 510 may transmit control information 638 which includes information about the relationship of UE-RS pre-coding, user specific data pre-coding, and other parameters in the network that along with a pre-defined rule 660 and mapping functions 670 may be used in estimating the data channel, i.e., the channel experienced by data 636.

In one embodiment, 16 channels 630 may be utilized h(ab): h11, h12, h13, h14, h21, h22, h23, h24, h31, h32, h33, h34, h41, h42, h43, h44; wherein a is representative of the transmitter node's 510 transmitting antennas 628 and b is representative of the UE's 550 receiving antennas 632.

Further, in one embodiment, the UE 550 includes a channel estimator 650 that performs a mapping function 654 to aid in channel estimation. The mapping function 654 is used to define the relationship between items including: CRS observations from CRS ports; UE-RS observations from the UE-RS ports; UE-RS precoding 646; and user specific data precoding 648.

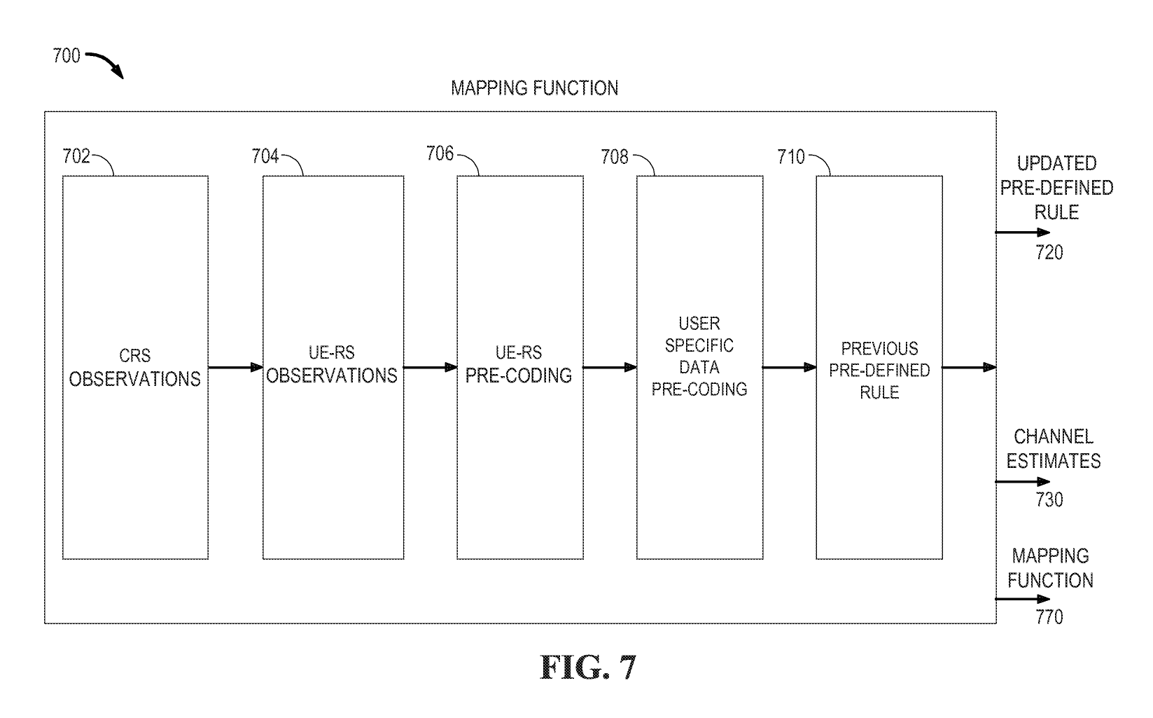

Referring briefly to FIG. 7, an example of mapping function components 700 are illustrated. Mapping function components 700 may include CRS observations 702, UE-RS observations 704, UE-RS precoding 706, user specific data precoding 708, and the previous predefined rule 710. Based upon the mapping function, to define the relationship between these mapping function components, channel estimates 730 are calculated such that channel estimation and demodulation is improved. Further, an updated pre-defined rule 720 is calculated based upon the mapping function. The mapping function itself 770 may also be transmitted.

The mapping function may be a linear mapping function. Further, the mapping function may be time and frequency dependent due to the multiplexing of time and frequency from the different transmit antennas of the transmitting node. The mapping function may based on semi-static or dynamic signaling.

Referring back to FIG. 6A, the channel estimator 650 implementing the mapping function 654 calculates channel estimates 655. The channel estimates are used to obtain the equivalent channel seen from the data 636 and for the purpose of data demodulation and data decoding 656. Some of this information such as pre-coding, rank, channel quality, pre-defined rules, and mapping functions may be transmitted back to the transmitting node 510.

As one example, the updated pre-defined rule 660, the mapping function 670, and the other information, may be transmitted from the UE 550 to the transmitter node 510 by an uplink (UL) grant. Further, the updated pre-defined rule 660, the mapping function 670, and the other information, may be transmitted from the transmitter node 510 to the UE 550 by a downlink (DL) grant as control information 638.

Thus, in one embodiment, feedback is accomplished by the recommended precoding and rank of operation being transmitted from the UE 550 to the transmitter 510, and, in this example, the pre-defined rules and mapping functions may also be incorporated at the time of computing the precoding operation and may be fed back to the transmitter 510, i.e. the precoding matrix reported takes into consideration the predefined rules and mapping functions. Further, the UE 550 may transmit a feedback signal to the transmitter 510 that includes channel quality, directionality, supportability rates, and the mapping function.

Thus, in one embodiment, for the joint use of CRS signals 632 and UE-RS signals 634 components such as: the mapping function 670 indicating the relation of the user specific data precoding 648 and the channels observed on CRS ports and UE-RS ports 642 and 644, the pre-defined rule 660 for sharing mapping functions between the UE 550 and the transmitting node 510, and a feedback mechanism for the UE 550 to compute preferred transmission parameters based on the UE-RS patterns and the mapping function associated with each pattern that is transmitted back to the transmitting node 510; may be utilized.

Referring briefly to FIG. 6B, FIG. 6B is a flowchart that illustrates a process 680 to implement channel estimation. At block 682, UE-RS and CRS are generated and transmitted from a transmitting node. The UE-RS and CRS are transmitted to a UE using a transmission scheme in accordance with a mapping function (block 684). The UE estimates the channel based upon CRS observations, UE-RS observations, and the mapping function (block 686). Data is transmitted from the transmitting node to the UE using the transmission scheme in accordance with the mapping function (block 688). The UE reads data from a channel that is estimated based upon the mapping function (block 690).

With reference again to FIG. 6A, in one embodiment, UE-RS 634 may be transmitted along a corresponding number of dominant channels 630 for data transmission while channel estimates for the remaining channels 630 may be inferred from previous UE-RS 634 and CRS 632 and the knowledge of the user specific data precoding 648 applied for data transmission. The precoder in this case does not need to be limited to the CRS antenna ports and may be defined across all the antennas that data transmission occurs from. In cases where the CRS antenna ports are obtained by antenna virtualization and the antenna ports for data transmission are different from CRS ports, the antenna virtualization can be made available at the UE.

The information to enable the channel estimation for the remaining channels may be made available at the UE 550 through DL signaling grants and/or the pre-defined set of rules 660. Joint channel estimation may also be performed for all of the channels transmitting UE-RS 634 and CRS 632 when the precoding information for all the channels is known.

In one embodiment, the UE 550 can use a combination of CRS 632 and UE-RS 634 for channel estimation by limiting the precoding operation on some of the channels 630 (e.g. Group A channels) to only be across the CRS antenna ports to a set of defined precoding options. As an example of possible precoding options, the Release 8 codebook is defined for 2 and 4 Tx antennas or antenna selection among the CRS antenna ports. The precoding for Group A channels may be shared with the UE 550 through signaling or the predefined set of rules 660. The channel estimate 655 for Group A channels may be obtained from CRS antenna ports 642 and precoding information 648. For the remaining channels, Group B channels, UE-RS 634 may be transmitted along the remaining number of channels 630.

The precoding operation for Group B channels can be transparent from the user's perspective and no signaling of the precoding operation for these layers is employed for the UE 550. In this case, the UE 550 can provide channel information feedback by considering the possible UE-RS 634 patterns and associated precoding options on the CRS ports 642 and optimizing a performance metric over this set.

As previously described, in one embodiment, for the joint use of CRS signals 632 and UE-RS signals 634 components such as: the mapping function 670 indicating the relation of the user specific data precoding 648 and the channels observed on CRS ports and UE-RS ports 642 and 644, the pre-defined rule 660 for sharing mapping functions between the UE 550 and the transmitting node 510, and a feedback mechanism for the UE 550 to compute preferred transmission parameters based on the UE-RS patterns and the mapping function associated with each pattern that is transmitted back to the transmitting node 510; may be utilized.

As an example, in one embodiment, the transmission of the data may occur on spatial directions that may be obtainable based on observations of the CRS ports 642 and the UE-RS ports 644. Thus, the data transmission may be across a precoded channel that can be estimated and reconstructed based on the mapping function 654 implemented by the channel estimator 650 dependent upon channel coefficients observed at the CRS and UE-RS ports 642 and 644.

For example, the transmission of multiple spatial channels of data, such as r, may be employed. In this case, a UE-RS pattern 634 corresponding to r1<=r channels and a mapping function 654 may be chosen. The UE 550 may be informed of the choice through a DL grant or other means. The UE-RS pattern 634 and the mapping function 654 are selected in such a manner that the user specific data precoding 648 is a linear combination of the directions of UE-RS 634 and the CRS 632. The pattern and location of UE-RS 634 and the technique to arrive at the directions observed by the user specific data precoding 648 is such that the UE 550 can determine these from the information that the UE has.

The mapping function 654 implemented by the channel estimator based upon the UE-RS observations from the UE-RS ports 644 and the CRS observations from the CRS ports 642 to the channel experienced by data can be a linear mapping, i.e., each data channel coefficient may be obtained by a linear combination of the channels at the CRS ports and UE specific RS ports. Furthermore, the mapping function 654 may be made available at the UE 550 by different possible means. For example, a mapping function 670 may be signaled to the UE 550 by the transmitting node 510 and/or can be given by a pre-determined rule 660 possibly depending on the previous information shared between the transmitting nodes 510 and the UE 550. Further, the mapping function 654 implemented may be restricted to a finite set of possible mappings. The set of possible mappings may be dependent on the UE-RS pattern 634 selected for transmission and also on the number of CRS ports. The set of possible mappings may also be based upon the number of UE-RS ports and other parameters related to the transmission of the data (e.g., number of data streams or spatial channels). Having a UE-RS dependent pattern 634, the UE 550 can choose a pattern and a possible mapping function 654 for that pattern such that some performance metric is maximized. In that case, the transmission of the multiple channels 630 of the data can occur with the UE-RS pattern 634 and the mapping function 654 chosen.

As examples, a mapping function 670 may be signaled by the transmitting node 510 to the UE 550 as a precoding index of Release 8 precoding structure carried in a downlink grant. The mapping function 670 may be based on the previously reported precoding indicators by the UE 550 that are available at the transmitting node 510 (e.g., from pre-defined rule 660). Further, the mapping function 670 may follow a deterministic rule that is possibly frequency-time dependent. The mapping function 670 may be determined by a combination of signaling from the UE 550 and a pre-defined and common rule 660 shared by the transmitting node 510 and the UE 550. For instance, the signaling can reveal information about the mapping of some of the spatial layers and the channel for other spatial layers are similar to channels obtained by the observations from the UE-RS ports 644. Moreover, the mapping function 670 can be configurable and adaptive and can be frequency/time dependent. As previously described, based upon all of this knowledge employed by the mapping function 654 implemented by the channel estimator 650, the UE 550 may perform joint channel estimation to estimate the precoded channel seen by the data.

As a further example, if transmission is done in a non-precoded manner, UE-RS 634 may correspond to non-precoded antenna ports of the UE 550 that are not carried out on CRS ports. Demodulation may be achieved using UE-RS 634 for some of the channels 630 and for the channels 630 that do not correspond to UE-RS 634, the precoding operation can be limited to the antenna ports for which CRS is present. Further, it is possible to limit the precoding operation for the channels 630 that are not represented by UE-RS 634 to antenna selection (e.g. antennas 631 of UE 550) among the CRS antenna ports. In this case, the precoding operation on data and demodulation reference signals is similar for channels 630. Antenna selection (e.g. antennas 631 of UE 550) can be signaled to the UE through a downlink (DL) grant.

As yet another example, the precoding operation may be limited on data for channels 630 beyond a defined threshold to a limited set, e.g., to Release 8 based precoding codebook. For example, with 4 CRS 632 advertised, demodulation may be based on UE-RS 634 for up to a rank, e.g., 4. Beyond rank 4, the precoding operation for the additional channels could be based on Release 8, 4 Tx precoding on the CRS antenna ports. The release 8 DL grant structure may be used to signal the choice of this precoding to the UE 550. UE-RS 634 may be transmitted along the corresponding number of dominant channels 630 while channel estimates for the remaining channels 630 may be inferred from the UE-RS 634, CRS 632, and the knowledge of DL precoder defined across all transmit antennas 628. The use of CRS 632 in demodulation may be based upon the parameters of the UE 550 and its transmission mode. For example, CRS 632 may be used for demodulation purposes if the rank of transmission is greater than a value or if the UE 550 is configured in a particular transmission mode. Further, the use of CRS 632 may be based on the parameters of legacy system configuration. As an example, the use of CRS 632 for demodulation may be configured for the case when the number of advertised CRS ports is greater than a value, e.g. 2.

UE-RS 634 may be a function of the UE 550 and system parameters, such as transmission mode, number of advertised CRS 632, rank of transmission, channel condition and modulation and coding parameters used. UE 550 and/or the transmitting node 510 may incorporate loss due to channel estimation and/or overhead associated with different demodulation reference signal patterns, when reporting preferred transmission mode or channel information to the transmitting node 510 and/or when scheduling the UE 550. Furthermore, the UE 550 may signal preferred UE-RS patterns and associated precoding structure to the transmitting node 510 (e.g., such as via the pre-defined rule 660). This information may be computed by the processor of the UE 550 by evaluating the performance for different precoding operations possible under different UE-RS patterns. As an example, the UE 550 can choose between using CRS antenna ports (and available precoding matrices defined for the CRS antenna ports) and using UE-RS 634 for demodulation purposes.

In another embodiment, the transmitting node 510 generates user specific reference (UE-RS) blocks 635 for multiple channel transmission that may be dependent upon the number of transmitted channels 630. In particular, the transmitting node 510 positions the UE-RS 610 over physical resource blocks (RBs) to generate the UE-RS blocks 635. Further, the transmitting node 510 may position the UE-RS blocks 635 over multiple contiguous resource block (RBs) as a function of a pre-determined number of RBs bundled together. The number of RBs may be bundled together based upon system patterns such as the rank of transmission. Moreover, the transmitting node 510 may time stagger the UE-RS blocks 635 over contiguous physical RBs to provide balancing between channel time-frequency variations and density of the UE-RS patterns. The UE-RS blocks 635 may be provided to a group of UEs 601 (Group UEs). Utilizing the previously-described channel estimation techniques, channel estimation may be performed based upon a combination of the UE-RS blocks 635, Group UEs 601, and CRS 632.

Thus, in some embodiments, the UE-RS blocks 635 may be generated for transmission over multiple channels 630 dependent upon the number of channels available for transmission. The UE-RS blocks 635 may be structured over multiple contiguous physical RBs and time staggered to improve channel estimation performance. Time/frequency patterns may be defined over one or more contiguous RBs, wherein the number of such blocks is configurable (e.g., defined per user and associated transferred channels). Time staggering for the UE-RS blocks 635 may be employed as a tradeoff/balance between time/frequency variation and the density of desired UE-RS blocks 635. As such, time staggering may be used in contiguous boxes associated with the time-frequency patterns, the location of the reference signal (RS) corresponding to a particular channel of transmission changes over time (e.g., generalizing a pattern to multiple RBs that are bundled together.)

In this embodiment, demodulation of the UE-RS blocks 635 and the common reference signals (CRS) 632 from the transmitter node 510 in conjunction with signaling from the transmitting nodes, enable the channel estimator 650 of the UE 550, as previously described, to obtain estimates of the channel experienced by data packets. Channel estimator 650 estimates channels based upon both received CRS 632 and received UE-RS blocks 635. Further, the channel estimator 650 estimates channels based upon CRS observation from CRS ports 642 and UE-RS observations from UE-RS ports 644. CRS 632 and UE-RS blocks 635 may be precoded or unprecoded. Also, the UE-RS blocks 635 may be transmitted in spatial directions specific to the UE. Moreover, the UE 550 can be the UE 550 or a group of UEs 601 in the Downlink scenarios and eNodeB or multiple NodeBs in the Uplink scenario.

In one example, a subset of UE-RS 634 are provided for a group of users in the system referred to as Group UEs 601. In this case, the relevant information of the RS (such as location, directions it is transmitted over), when present, can be signaled to the group of intended UEs 601 or it can be based on the pre-defined rule 660 known at UE(s) 601 and transmitting node(s) 510.

In another example, to use a combination of reference signals for channel estimation at demodulation, UE 550 can use a combination of UE-RS 634, UE-RS blocks 635, and CRS 632 to perform channel estimation. As such, the relevant information regarding constructing the channel experienced by data from the channel observed by different RS structures may be obtained by signaling to the UE or the pre-defined rule 660.

In one embodiment, for the joint use of CRS signals 632, UE-RS signals 634, and UE-RS blocks 635 components such as: the mapping function 670 indicating the relation of the user specific data precoding 648 and the channels observed on CRS ports and UE-RS ports 642 and 644, the pre-defined rule 660 for sharing mapping functions between the UE 550 and the transmitting node 510, and a feedback mechanism for the UE 550 to compute preferred transmission parameters based on the UE-RS patterns and mapping function associated with each pattern that is transmitted back to the transmitting node 510; may be utilized. The UE 550 includes a channel estimator 650 that performs the mapping function 654 to aid in channel estimation. The mapping function 654 is used to define the relationship between items including: CRS observations from CRS ports 642; UE-RS observations from the UE-RS ports 644; UE-RS precoding 646, and user specific data precoding 648.

Furthermore, the structure and pattern of the UE-RS blocks 635 may be dependent on different UEs 601 and system parameters, such as transmission mode, number of advertised CRS 632, rank of transmission, channel conditions (time and frequency variations) and modulation and coding parameters used in data packet transmission. The structure and pattern of the UE-RS blocks 635 may also be dependent on the number of users of a particular type or group (for instance, users with transmission rank of greater than a threshold). In one aspect, the density and frequency placement of the UE-RS blocks 635 can be dependent on the rank of transmission, or the frequency selectivity of the channel.

In another embodiment, the density and time placement of the UE-RS blocks 635 may be dependent on the rank of transmission, the time selectivity (and variations) of the channel. The pattern and structure of the UE-RS blocks 635 may be modified to be dependent on the frequency-time resources allocated for data transmission to the UEs 601. For example, in one embodiment, the UE-RS blocks 635 may be structured over multiple contiguous physical RBs in frequency and/or time. Another embodiment enables the number of RBs over which the pattern is defined to be dependent upon the receiving UE 550 and system parameters such as rank of transmission and other parameters mentioned above.

According to one embodiment, the UE-RS blocks 635 may be placed over multiple contiguous physical RBs (referred to as a bundle) to define a bundle size, e.g. the placement of UE-RS blocks 635 over a bundle of 2 PRB can be different from a bundle of 4 PRB and the like. In one embodiment, patterns with lower density UE-RS can be used for larger bundle sizes.

In a related embodiment, time-staggered UE-RS blocks 635 can be used for providing a good trade-off between capturing the time and frequency variation of the channel especially for larger bundle size patterns, and/or patterns with lower density of UE-RS desired. For instance in this case, the pattern for larger bundle sizes can be obtained by time-staggering a pattern defined for smaller RB size.

In another embodiment, the location of UE-RS blocks 635 can be fixed (e.g., across different ranks); however the mapping of the UE-RS blocks 635 for particular channels 630 to the reserved UE-RS blocks 635 locations can be changing with the rank of transmission and/or bundle size. For instance, for bundle sizes larger than one, it is possible to switch the position of the UE-RS blocks 635 between two groups of channels from one resource block (RB) to the next RB in the bundle. As an example in this case, odd RBs in the bundle will have a pattern similar to the 1st RB in the bundle and the even RBs will have the pattern in which UE-RS blocks 635 of channels {1,2,3,4} is switched with those of channels {5,6,7,8} in 1st RB pattern.

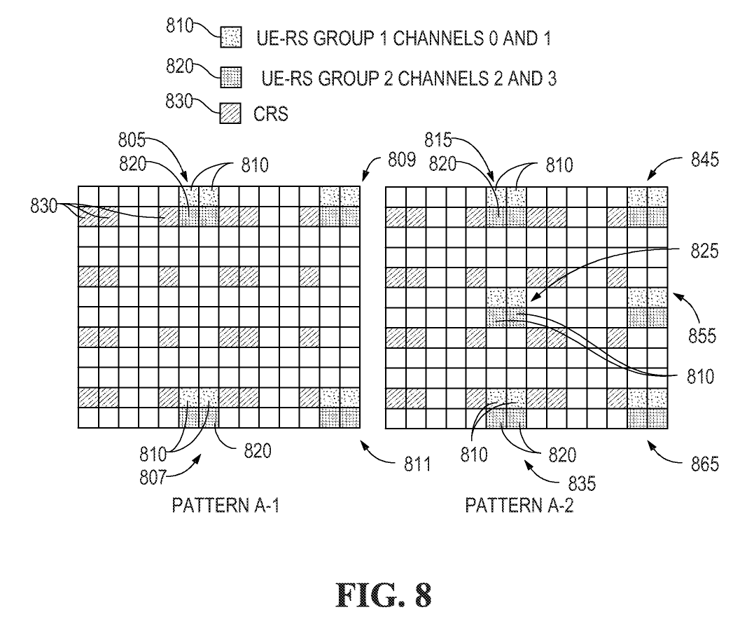

For example, FIG. 8 illustrates a particular extension of UE-RS patterns to a higher number of channels based upon different patterns. Pattern A-1 and pattern A-2 have different densities and are defined for a rank up to 4.

As can be seen in pattern A-1 of FIG. 8, UE-RS are positioned over physical resource blocks (RBs) to create UE-RS blocks. As an example, a first UE-RS block 805 is created that is formed by UE-RS group 1 over channels 0 and 1 810 and by UE-RS group 2 over channels 2 and 3 820. Similarly, UE-RS blocks 807, 809, and 811 are created. CRS 830 are interspersed between the UE-RS blocks.

As can be seen in pattern A-2 of FIG. 8, UE-RS are positioned over physical resource blocks (RBs) to create UE-RS blocks that have a different density than that of pattern A-2. As an example, a first UE-RS block 815 is created that is formed by UE-RS group 1 over channels 0 and 1 810 and by UE-RS group 2 over channels 2 and 3 820. Similarly, UE-RS blocks 825, 835, 845, 855, and 865 are created. CRS 830 are interspersed between the UE-RS blocks.

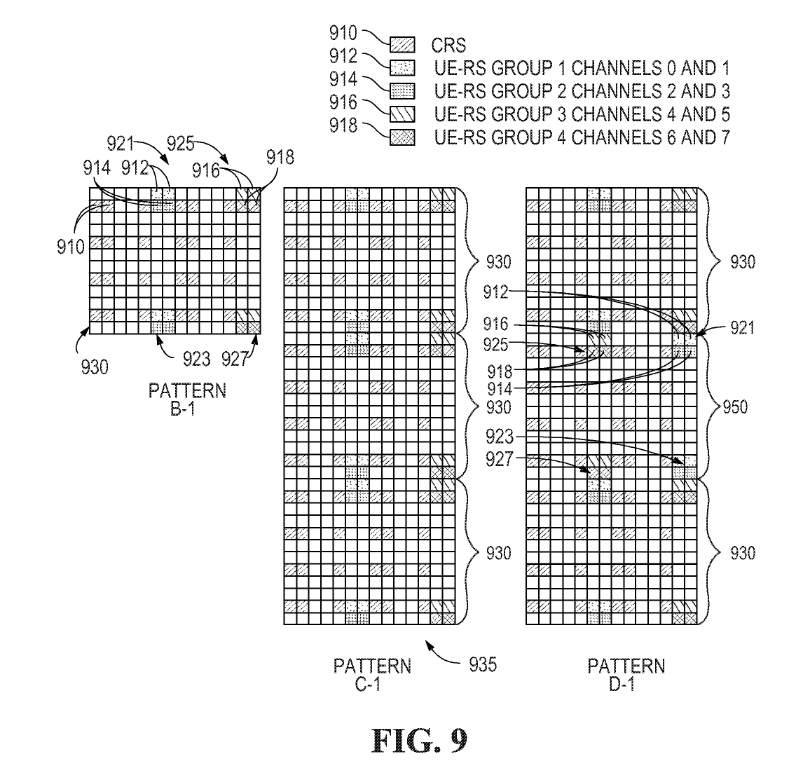

As another example, FIG. 9 illustrates another embodiment that shows a particular extension of UE-RS patterns to a higher number of channels based upon different patterns. As shown in FIG. 9, pattern B-1 includes a rank of 8 by extending the mapping of the UE-RS locations in pattern A-1, from FIG. 8, to include 8 channels.

As can be seen in pattern B-1 of FIG. 9, UE-RS are positioned over physical resource blocks (RBs) to create UE-RS blocks. As an example, a first UE-RS block 921 is created that is formed by UE-RS group 1 over channels 0 and 1 912 and by UE-RS group 2 over channels 2 and 3 914. Similarly, UE-RS block 923 is created. Another type of UE-RS block 925 is created that is formed by UE-RS group 3 over channels 4 and 5 916 and by UE-RS group 4 over channels 6 and 7 918. Similarly, UE-RS block 927 is created. CRS 910 are interspersed between the UE-RS blocks. Thus, a UE-RS block 930 is formed having pattern B-1.

In one embodiment, a UE-RS block may be positioned over multiple contiguous resource block (RBs) as a function of a pre-determined number of RBs bundled together. Looking at pattern C-1 935, pattern C-1 935 shows a bundled version of contiguous UE-RS blocks 930 having pattern B-1.

In another embodiment, UE-RS blocks may be time staggered over contiguous physical resource blocks (RBs) to provide balancing between channel time-frequency variations and density of the UE-RS. Pattern D-1 of FIG. 9 shows another bundling of the UE-RS blocks 930 having pattern B-1 in which the mapping is alternating between the odd RBs and even RBs for different groups of channels as discussed previously. As can be seen in pattern D-1 of FIG. 9 staggering is provided across the RBs of the bundle. In particular, in this example, the odd RBs correspond to UE-RS blocks 930 having pattern B-1 whereas the even RBs, RB 950, illustrates the opposite mapping of pattern B-1.

In another embodiment, it is possible to define another mapping for obtaining rank 8 UE-RS blocks similar to pattern B-1 of FIG. 9 and to implement staggering of the RS for different groups of channels within the RB. The RS pattern for bundles of size larger than 1 can occur by repeating the pattern for one RB, as will be described.

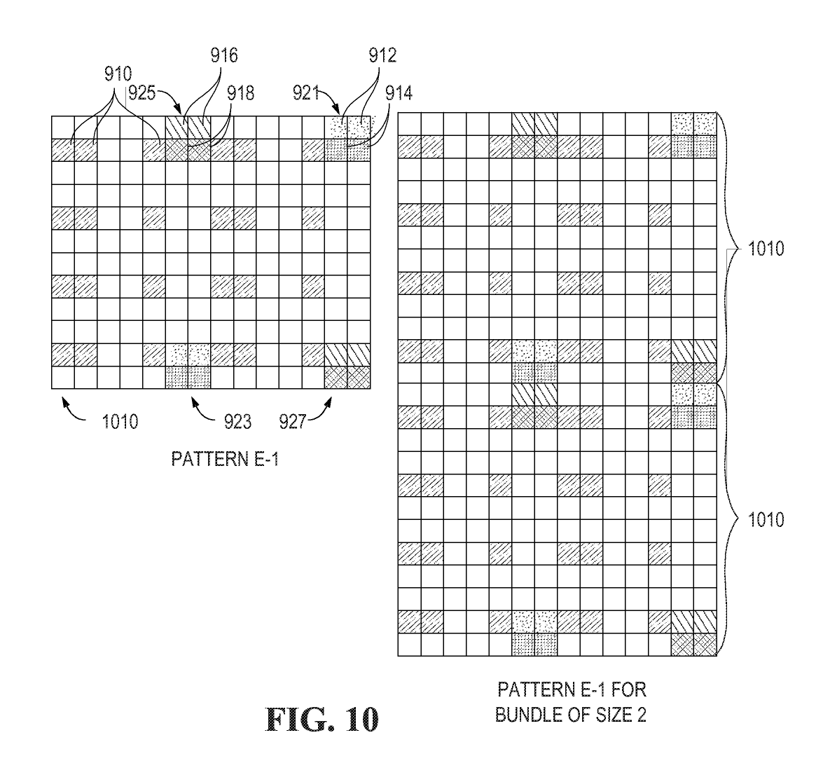

Looking at FIG. 10, FIG. 10 shows a reconfiguration of pattern B-1 of FIG. 9 to implement time staggering. As an example, the UE-RS block 925 is created and is formed by UE-RS group 3 over channels 4 and 5 916 and by UE-RS group 4 over channels 6 and 7 918. Similarly, UE-RS block 927 is created. Another type of UE-RS block 921 is created by UE-RS group 1 over channels 0 and 1 912 and by UE-RS group 2 over channels 2 and 3 914. Similarly, UE-RS block 923 is created. CRS 910 are interspersed between the UE-RS blocks. Thus, a UE-RS block 1010 is formed having pattern E-1. Further, UE-RS blocks 1010 having pattern E-1 may be positioned over multiple contiguous resource block (RBs) as a function of a pre-determined number RBs bundled together. As an example, FIG. 10 shows a bundled version of 2 contiguous UE-RS blocks 1010 having pattern E-1.

Thus, UE-RS block 1010 having pattern E-1 represents a staggered arrangement—wherein time is represented on the horizontal axis and frequency is represented by the vertical axis. As illustrated, the UE reference signals are distributed in different columns (as opposed to being limited to edge columns)—and hence represent staggering occurring in time, wherein such staggering can further be employed as a tool for assigning locations to different channels, which can improve channel estimation performance.

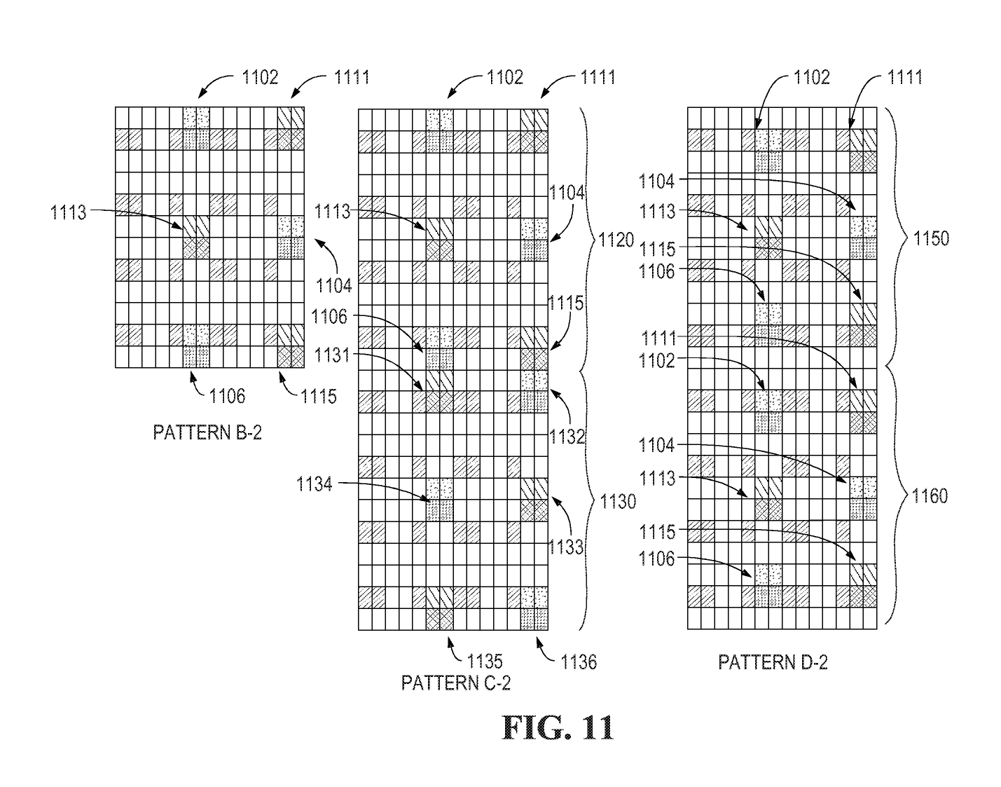

In another embodiment, different groups of channels may be time staggered as illustrated in FIG. 11. For example, pattern B-2 of FIG. 11 illustrates the extension of pattern A-2 of FIG. 8 into 8 channels utilizing the previously-described UE-RS blocks of FIGS. 8 and 9. As previously described, two different types of UE-RS blocks may formed, a UE-RS group over channels 0-3 (hereinafter primary UE-RS group) and a UE-RS group over channels 4-7 may formed (hereinafter secondary UE-RS group).

As can be seen in FIG. 11, pattern B-2 shows three primary UE-RS groups 1102, 1104, and 1106 are formed and three secondary UE-RS groups 1111, 1113, and 1115 are formed. As can be seen in pattern C-2 of FIG. 11, a pattern for bundled RBs 1120 and 1130 can be obtained by using the pattern B-2 for bundled RBs 1120 and alternating the mapping of channels to RS locations between even and odd RBs, as shown in bundled RBs 1130, illustrating reversed formation of primary UE-RS groups 1132, 1134, and 1136 and reversed formation of secondary UE-RS groups 1131, 1133, and 1135. Alternatively, a pattern for bundled RBs may be obtained by first shifting the pattern of B-2 in frequency and repeating the pattern across RBs to provide a uniform sampling of the frequency as shown in pattern D-2 which includes bundled RBs 1150 and 1160.

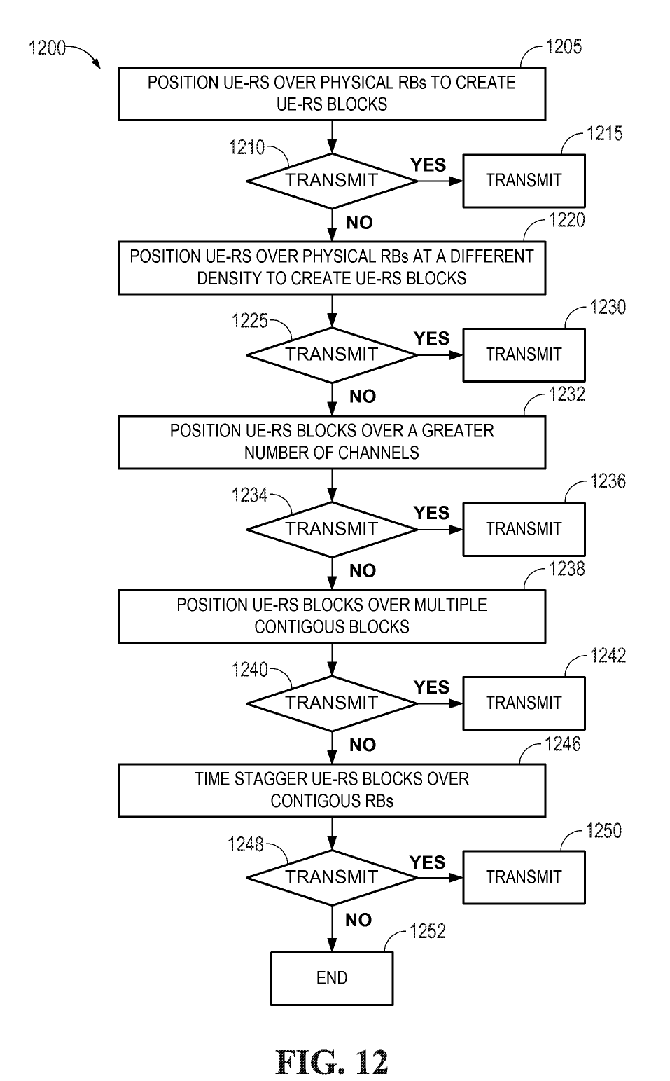

Referring briefly to FIG. 12, FIG. 12 is a flowchart that illustrates a process 1200 to create UE-RS blocks. At block 1205, UE-RS are positioned over physical RBs to create UE-RS blocks (e.g. FIG. 8, pattern A1). At decisions block 1210 it is determined whether these UE-RS blocks are suitable for transmission, if so they are transmitted (block 1215), if not process 1200 continues. At block 1220, UE-RS are positioned over physical RBs at a different density to create UE-RS blocks (e.g. FIG. 8, pattern A2). At decisions block 1225 it is determined whether these UE-RS blocks are suitable for transmission, if so they are transmitted (block 1230), if not process 1200 continues. At block 1232, UE-RS blocks are positioned over a greater number of channels (e.g. FIG. 9, pattern B1). At decisions block 1234 it is determined whether these UE-RS blocks are suitable for transmission, if so they are transmitted (block 1236), if not process 1200 continues. At block 1238, UE-RS blocks are positioned over multiple contiguous blocks (e.g. FIG. 9, pattern C1). At decisions block 1240 it is determined whether these UE-RS blocks are suitable for transmission, if so they are transmitted (block 1242), if not process 1200 continues. At block 1246, UE-RS blocks are time staggered over contiguous blocks (e.g. FIG. 9, pattern D1). At decisions block 1248 it is determined whether these UE-RS blocks are suitable for transmission, if so they are transmitted (block 1250), if not process 1200 may end at block 1252.

However, as previously described in detail, there are wide variety of different types of UE-RS block configurations, channel number selections, and time staggering schemes that may be utilized and a process can be utilized that implements any combination of these types of schemes.

As previously described with reference to FIG. 6A, the system 600 can comprise one or more base stations or transmitting nodes 510 in one or more sectors that receive, transmit, repeat, and so forth, wireless communication signals to each other and/or to one or more UEs 550. Each transmitting node 510 can comprise multiple transmitter chains and receiver chains (e.g., one for each transmit and receive antenna), each of which can in turn comprise a plurality of components associated with signal transmission and reception (e.g., processors, modulators, multiplexers, demodulators, demultiplexers, antennas, and so forth). Each UE may comprise one or more transmitter chains and receiver chains, which can be utilized for a multiple input multiple output (MIMO) system. Moreover, each transmitter and receiver chain can comprise a plurality of components associated with signal transmission and reception (e.g., processors, modulators, multiplexers, demodulators, demultiplexers, antennas, and so on), as will be appreciated by one skilled in the art.

Thus, as previously explained, transmitting node 510 generates user specific reference (UE-RS) blocks 635 for multiple channel transmission that may be dependent upon the number of transmitted channels 630. In particular, transmitting node 510 positions the UE-RS 634 over physical resource blocks (RBs) to generate the UE-RS blocks 635 (such as the UE-RS groups of FIG. 8). Further, the transmitting node 510 may position the UE-RS blocks 635 over multiple contiguous resource block (RBs) as a function of a pre-determined number of RBs bundled together (such as the UE-RS groups of FIG. 9). The number of RBs may be bundled together based upon system patterns such as the rank of transmission. Moreover, the transmitting node 510 may time stagger the UE-RS block 635 over contiguous physical RBs to provide balancing between channel time-frequency variations and density of the UE-RS patterns (such as the UE-RS groups of FIGS. 9, 10, and 11). The UE-RS blocks 635 may be provided to a group of UEs 601 (Group UEs). Utilizing the previously-described channel estimation techniques, channel estimation may be performed based upon a combination of the UE-RS blocks 635, Group UEs 601, and CRS 632.

In essence, as explained earlier, the system 600 incorporates designing the UE-RS blocks 635 for multiple channel transmission by defining the structure over multiple contiguous physical RB and time staggering to improve channel estimation performance. As such, time/frequency patterns can be defined over one or more contiguous resource blocks, wherein the number of such blocks is configurable (e.g., defined per user and associated transferred layers). Further, it should be appreciated that the UE-RS block operation can be done irrespective of CRS and UE-RS joint estimation, i.e., in the case of UE-RS clock and RB bundling, the UE 550 may rely only upon UE-RS observation for estimating the channel and the joint use of CRS and UE-RS is not required.

Thus, by utilizing the previously described embodiments, for the joint use of CRS signals 632, UE-RS signals 634, and UE-RS blocks 635 components such as: the mapping function 670 indicating the relation of the user specific data precoding 648 and the channels observed on CRS ports and UE-RS ports 642 and 644, the pre-defined rule 660 for sharing mapping functions between the UE 550 and the transmitting node 510, and a feedback mechanism for the UE 550 to compute preferred transmission parameters based on the UE-RS patterns and the mapping function associated with each pattern that is transmitted back to the transmitting node 510; may be utilized. The UE 550 includes a channel estimator 650 that implements the mapping function 654 to aid in channel estimation. The mapping function 654 is used to define the relationship between items including: CRS observations from CRS ports 642; UE-RS observations from the UE-RS ports 644; UE-RS precoding 646, and user specific data precoding 648.

In one configuration, as previously described, the apparatus including transmitting node 510 and user 550 for wireless communication includes: means for generating one or more user specific reference signals (UE-RS) and one or more common reference signals (CRS) at a transmitting node; means for transmitting the UE-RS and the CRS to a user (UE) using a transmission scheme in accordance with a mapping function to enable the UE to estimate a channel based upon CRS observations, UE-RS observations, and the mapping function; means for transmitting data using the transmission scheme in accordance with the mapping function. In one aspect, the aforementioned means may be the processor(s) (520, 530, 542) of the transmitting node 510 and the processor(s) (538, 560, and 570) of the UE 550 in which the invention resides from (FIGS. 5 and 6A) as configured to perform the functions recited by the aforementioned means. Further, the transmitting node 510 and user 550 may be used to perform all of previously described means for performing the previously described functions. In another aspect, the aforementioned means may be a module or any apparatus configured to perform the functions recited by the aforementioned means.

In describing the previously discussed channels, it should be appreciated that, in one aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. Logical Traffic Channels comprise a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels comprises: Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), Paging Indicator Channel (PICH), Load Indicator Channel (LICH)

The UL PHY Channels comprises: Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), Broadband Pilot Channel (BPICH)

Other terms include: 3G 3rd Generation, 3GPP 3rd Generation Partnership Project, ACLR Adjacent channel leakage ratio, ACPR Adjacent channel power ratio, ACS Adjacent channel selectivity, ADS Advanced Design System, AMC Adaptive modulation and coding, A-MPR Additional maximum power reduction, ARQ Automatic repeat request, BCCH Broadcast control channel, BTS Base transceiver station, CDD Cyclic delay diversity, CCDF Complementary cumulative distribution function, CDMA Code division multiple access, CFI Control format indicator, Co-MIMO Cooperative MIMO, CP Cyclic prefix, CPICH Common pilot channel, CPRI Common public radio interface, CQI Channel quality indicator, CRC Cyclic redundancy check, DCI Downlink control indicator, DFT Discrete Fourier transform, DFT-SOFDM Discrete Fourier transform spread OFDM, DL Downlink (base station to subscriber transmission), DL-SCH Downlink shared channel, D-PHY 500 Mbps physical layer, DSP Digital signal processing, DT Development toolset, DVSA Digital vector signal analysis, EDA Electronic design automation, E-DCH Enhanced dedicated channel, E-UTRAN Evolved UMTS terrestrial radio access network, eMBMS Evolved multimedia broadcast multicast service, eNB Evolved Node B, EPC Evolved packet core, EPRE Energy per resource element, ETSI European Telecommunications Standards Institute, E-UTRA Evolved UTRA, E-UTRAN Evolved UTRAN, EVM Error vector magnitude, and FDD Frequency division duplex.

Still yet other terms include FFT Fast Fourier transform, FRC Fixed reference channel, FS1 Frame structure type 1, FS2 Frame structure type 2, GSM Global system for mobile communication, HARQ Hybrid automatic repeat request, HDL Hardware description language, HI HARQ indicator, HSDPA High speed downlink packet access, HSPA High speed packet access, HSUPA High speed uplink packet access, IFFT Inverse FFT, IOT Interoperability test, IP Internet protocol, LO Local oscillator, LTE Long term evolution, MAC Medium access control, MBMS Multimedia broadcast multicast service, MBSFN Multicast/broadcast over single-frequency network, MCH Multicast channel, MIMO Multiple input multiple output, MISO Multiple input single output, MME Mobility management entity, MOP Maximum output power, MPR Maximum power reduction, MU-MIMO Multiple user MIMO, NAS Non-access stratum, OBSAI Open base station architecture interface, OFDM Orthogonal frequency division multiplexing, OFDMA Orthogonal frequency division multiple access, PAPR Peak-to-average power ratio, PAR Peak-to-average ratio, PBCH Physical broadcast channel, P-CCPCH Primary common control physical channel, PCFICH Physical control format indicator channel, PCH Paging channel, PDCCH Physical downlink control channel, PDCP Packet data convergence protocol, PDSCH Physical downlink shared channel, PHICH Physical hybrid ARQ indicator channel, PHY Physical layer, PRACH Physical random access channel, PMCH Physical multicast channel, PMI Pre-coding matrix indicator, P-SCH Primary synchronization signal, PUCCH Physical uplink control channel, and PUSCH Physical uplink shared channel.

Other terms include QAM Quadrature amplitude modulation, QPSK Quadrature phase shift keying, RACH Random access channel, RAT Radio access technology, RB Resource block, RF Radio frequency, RFDE RF design environment, RLC Radio link control, RMC Reference measurement channel, RNC Radio network controller, RRC Radio resource control, RRM Radio resource management, RS Reference signal, RSCP Received signal code power, RSRP Reference signal received power, RSRQ Reference signal received quality, RSSI Received signal strength indicator, SAE System architecture evolution, SAP Service access point, SC-FDMA Single carrier frequency division multiple access, SFBC Space-frequency block coding, S-GW Serving gateway, SIMO Single input multiple output, SISO Single input single output, SNR Signal-to-noise ratio, SRS Sounding reference signal, S-SCH Secondary synchronization signal, SU-MIMO Single user MIMO, TDD Time division duplex, TDMA Time division multiple access, TR Technical report, TrCH Transport channel, TS Technical specification, TTA Telecommunications Technology Association, TTI Transmission time interval, UCI Uplink control indicator, UE User equipment, UL Uplink (subscriber to base station transmission), UL-SCH Uplink shared channel, UMB Ultra-mobile broadband, UMTS Universal mobile telecommunications system, UTRA Universal terrestrial radio access, UTRAN Universal terrestrial radio access network, VSA Vector signal analyzer, W-CDMA Wideband code division multiple access.

It is noted that various aspects are described herein in connection with a terminal. A terminal can also be referred to as a system, a user device, a subscriber unit, subscriber station, mobile station, mobile device, remote station, remote terminal, access terminal, user terminal, user agent, or user equipment. A user device can be a cellular telephone, a cordless telephone, a Session Initiation Protocol (SIP) phone, a wireless local loop (WLL) station, a PDA, a handheld device having wireless connection capability, a module within a terminal, a card that can be attached to or integrated within a host device (e.g., a PCMCIA card) or other processing device connected to a wireless modem.

Moreover, aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving voice mail or in accessing a network such as a cellular network. Of course, those skilled in the art will recognize many modifications may be made to this configuration without departing from the scope or spirit of what is described herein.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

What is claimed is:

1. A wireless communications method, comprising:
generating one or more user specific reference signals (UE-RS) and one or more common reference signals (CRS) at a transmitting node;
transmitting the UE-RS and the CRS using a transmission scheme in accordance with a mapping function to enable the user equipment (UE) to estimate a channel based upon CRS observations, UE-RS observations, and the mapping function; and
transmitting data using the transmission scheme in accordance with the mapping function.

2. The method of claim 1, further comprising selecting spatial channels based upon the mapping function.

3. The method of claim 1, wherein the mapping function is used to define the relation of precoded channels, channels observed on CRS ports, and channels observed on UE-RS ports, in order to enable channel estimation.

4. The method of claim 3, wherein data is transmitted across a precoded channel that is estimated and reconstructed based upon the mapping function that includes channel coefficients associated with the CRS ports and the UE-RS ports.

5. The method of claim 3, wherein data required to enable channel estimation at the UE is based upon a pre-defined rule shared between the UE and the transmitter node.

6. The method of claim 5, further comprising computing and transmitting a feedback signal from the UE to the transmitting node indicating at least one of channel quality, directionality, and supportability rate according to the mapping function known by the UE and the transmitting node.

7. The method of claim 5, further comprising computing and transmitting a feedback signal from the UE to the transmitting node indicating a set of mapping functions to be used in data transmission to the UE.

8. The method of claim 5, wherein the mapping function is based on semi-static or dynamic signaling or a predefined rule known at the UE.

9. The method of claim 5, wherein the mapping function is a linear mapping function.

10. The method of claim 5, wherein the mapping function is time and frequency dependent.

11. The method of claim 5, wherein the mapping function is signaled to the UE from the transmitter node through a downlink (DL) grant.

12. The method of claim 1, further comprising positioning the UE-RS over physical resource blocks (RBs).

13. The method of claim 12, further comprising positioning the UE-RS over multiple contiguous physical resource blocks (RBs) as a function of a pre-determined number of RBs bundled together.

14. The method of claim 13, further comprising time staggering the UE-RS over contiguous physical resource blocks (RBs) to provide balancing between channel time-frequency variations and density of the UE-RS.

15. The method of claim 13, wherein the UE-RS is provided for a group of users (Group UE-RS).

16. The method of claim 15, further comprising performing channel estimation based upon a combination of UE-RS, Group UE-RS, and CRS.

17. The method of claim 15, wherein the number of RBs bundled together is based upon system parameters including at least rank of transmission.

18. A communications apparatus, comprising:
a memory that retains instructions for:
generating one or more user specific reference signals (UE-RS) and one or more common reference signals (CRS);
transmitting the UE-RS and the CRS using a transmission scheme in accordance with a mapping function to enable a user equipment (UE) to estimate a channel based upon CRS observations, UE-RS observations, and the mapping function;
transmitting data using the transmission scheme in accordance with the mapping function; and
a processor that executes the instructions.

19. The communications apparatus of claim 18, wherein the memory further retains instructions for selecting spatial channels based upon the mapping function.

20. The communications apparatus of claim 18, wherein the memory further retains instructions such that the mapping function is used to define the relation of precoded channels, channels observed on CRS ports, and channels observed on UE-RS ports, in order to enable channel estimation.

21. The communications apparatus of claim 20, wherein the memory further retains instructions such that data is transmitted across a precoded channel that is estimated and reconstructed based upon the mapping function that includes channel coefficients associated with the CRS ports and the UE-RS ports.

22. The communications apparatus of claim 20, wherein data required to enable channel estimation at the UE is based upon a pre-defined rule shared between the UE and the transmitter node.

23. The communications apparatus of claim 22, wherein the memory further retains instructions for receiving and processing a feedback signal received from the UE indicating at least one of channel quality, directionality, and supportability rate according to the mapping function known by the UE and the transmitting node.

24. The communications apparatus of claim 22, wherein the mapping function is based on semi-static or dynamic signaling or a predefined rule known at the UE.

25. The communications apparatus of claim 22, wherein the mapping function is a linear mapping function.

26. The communications apparatus of claim 22, wherein the mapping function is time and frequency dependent.

27. The communications apparatus of claim 22, wherein the mapping function is signaled to the UE through a downlink (DL) grant.

28. The communications apparatus of claim 18, wherein the memory further retains instructions for positioning the UE-RS over physical resource blocks (RBs).

29. The communications apparatus of claim 28, wherein the memory further retains instructions for positioning the UE-RS over multiple contiguous physical resource blocks (RBs) as a function of a pre-determined number of RBs bundled together.

30. The communications apparatus of claim 29, wherein the memory further retains instructions for time staggering the UE-RS over contiguous physical resource blocks (RBs) to provide balancing between channel time-frequency variations and density of the UE-RS.

31. The communications apparatus of claim 29, wherein the UE-RS is provided for a group of users (Group UE-RS).

32. The communications apparatus of claim 31, wherein channel estimation is based upon a combination of UE-RS, Group UE-RS, and CRS.

33. The communications apparatus of claim 29, wherein the number of RBs bundled together is based upon system patterns including at least rank of transmission.

34. An apparatus operable in a wireless communication system, the apparatus comprising:
means for generating one or more user specific reference signals (UE-RS) and one or more common reference signals (CRS) at a transmitting node;
means for transmitting the UE-RS and the CRS using a transmission scheme in accordance with a mapping function to enable a user equipment (UE) to estimate a channel based upon CRS observations, UE-RS observations, and the mapping function; and
means for transmitting data using the transmission scheme in accordance with the mapping function.

35. The apparatus of claim 34, further comprising means for selecting spatial channels based upon the mapping function.

36. The apparatus of claim 34, wherein the mapping function is used to define the relation of precoded channels, channels observed on CRS ports, and channels observed on UE-RS ports, in order to enable channel estimation.

37. The apparatus of claim 36, further comprising means for transmitting data across a precoded channel that is estimated and reconstructed based upon the mapping function that includes channel coefficients associated with the CRS ports and the UE-RS ports.

38. The apparatus of claim 36, wherein data required to enable channel estimation at the UE is based upon a pre-defined rule shared between the UE and the transmitter node.

39. The apparatus of claim 37, further comprising means for computing and transmitting a feedback signal from the UE indicating at least one of channel quality, directionality, and supportability rate according to the mapping function know by the UE and the transmitter node.

40. The apparatus of claim 37, further comprising means for computing and transmitting a feedback signal from the UE to the transmitting node indicating a set of mapping functions to be used in data transmission to the UE.

41. The apparatus of claim 37, wherein the mapping function is based on semi-static or dynamic signaling or a predefined rule known at the UE.

42. The apparatus of claim 37, wherein the mapping function is a linear mapping function.

43. The apparatus of claim 37, wherein the mapping function is time and frequency dependent.

44. The apparatus of claim 37, further comprising means for signaling the mapping function to the UE through a downlink (DL) grant.

45. The apparatus of claim 34, further comprising means for positioning the UE-RS over physical resource blocks (RBs).

46. The apparatus of claim 45, further comprising means for positioning the UE-RS over multiple contiguous physical resource blocks (RBs) as a function of a pre-determined number of RBs bundled together.

47. The apparatus of claim 46, further comprising means for time staggering the UE-RS over contiguous physical resource blocks (RBs) to provide balancing between channel time-frequency variations and density of the UE-RS.

48. The apparatus of claim 46, wherein the UE-RS is provided for a group of users (Group UE-RS).

49. The apparatus of claim 48, further comprising means for performing channel estimation based upon a combination of UE-RS, Group UE-RS, and CRS.

50. The apparatus of claim 46, wherein the number of RBs bundled together is based upon system parameters including at least rank of transmission.

51. A user communications apparatus, comprising:
a memory that retains instructions for:
receiving one or more user specific reference signals (UE-RS) and one or more common reference signals (CRS);
implementing a mapping function based upon CRS observations and UE-RS observations to perform channel estimation;
decoding data based upon the channel estimation; and
a processor that executes the instructions.

52. The user communications apparatus of claim 51, wherein the memory further retains instructions such that the mapping function is used to define the relation of precoded channels, channels observed on CRS ports, and channels observed on UE-RS ports, in order to enable channel estimation.

53. The user communications apparatus of claim 52, wherein the memory further retains instructions such that data is estimated and reconstructed based upon the mapping function that includes channel coefficients associated with the CRS ports and the UE-RS ports.

54. The user communications apparatus of claim 52, wherein data required to enable channel estimation is based upon a pre-defined rule.

55. The user communications apparatus of claim 52, wherein the memory further retains instructions for generating a feedback signal indicating at least one of channel quality, directionality, supportability rate, and the mapping function, the feedback signal being transmitted to the transmitting node.

56. The user communications apparatus of claim 52, wherein the mapping function is based on semi-static or dynamic signaling or a predefined rule know at the UE.

57. The user communications apparatus of claim 52, wherein the mapping function is time and frequency dependent.

58. The user communications apparatus of claim 52, wherein the mapping function is signaled through a downlink (DL) grant.

59. The user communications apparatus of claim 51, wherein the memory further retains instructions for processing UE-RS received over physical resource blocks (RBs).

60. The user communications apparatus of claim 59, wherein the memory further retains instructions for processing UE-RS received over multiple contiguous physical resource blocks (RBs) bundled together.

61. The user communications apparatus of claim 60, wherein the memory further retains instructions for processing time staggered UE-RS resource blocks (RBs).

62. A computer program product, comprising:
a computer-readable medium comprising code for:
generating one or more user specific reference signals (UE-RS) and one or more common reference signals (CRS) at a transmitting node;
transmitting the UE-RS and the CRS using a transmission scheme in accordance with a mapping function to enable a user equipment (UE) to estimate a channel based upon CRS observations, UE-RS observations, and the mapping function; and
transmitting data using the transmission scheme in accordance with the mapping function.

63. The computer program product of claim 62, further comprising code for selecting spatial channels based upon the mapping function.

64. The computer program product of claim 62, wherein the mapping function is used to define the relation of precoded channels, channels observed on CRS ports, and channels observed on UE-RS ports, in order to enable channel estimation.

65. The computer program product of claim 64, further comprising code for transmitting data across a precoded channel that is estimated and reconstructed based upon the mapping function that includes channel coefficients associated with the CRS ports and the UE-RS ports.

66. The computer program product of claim 64, further comprising code for enabling channel estimation at the UE based upon a pre-defined rule shared between the UE and the transmitter node.

67. The computer program product of claim 66, further comprising code for transmitting a feedback signal from the UE to the transmitting node indicating at least one of channel quality, directionality, supportability rate according to the mapping function known by the UE and the transmitting node.

68. The computer program product of claim 66, wherein the mapping function is based on semi-static or dynamic signaling or a predefined rule known at the UE.

69. The computer program product of claim 66, wherein the mapping function is time and frequency dependent.

70. The computer program product of claim 66, further comprising code for signaling the mapping function to the UE from the transmitter node through a downlink (DL) grant.

71. The computer program product of claim 62, further comprising code for positioning the UE-RS over physical resource blocks (RBs).

72. The computer program product of claim 71, further comprising code for positioning the UE-RS over multiple contiguous physical resource blocks (RBs) as a function of a pre-determined number of RBs bundled together.

73. The computer program product of claim 72, further comprising code for time staggering the UE-RS over contiguous physical resource blocks (RBs) to provide balancing between channel time-frequency variations and density of the UE-RS.

74. The computer program product of claim 72, wherein the UE-RS is provided for a group of users (Group UE-RS).

75. The computer program product of claim 74, further comprising code for performing channel estimation based upon a combination of UE-RS, Group UE-RS, and CRS.
